(19) United States
(12) Patent Application Publication
(10) Pub. No.: US 2025/0205872 A1
(43) Pub. Date: Jun. 26, 2025

(54) Grabber Tool with Bendable Arm Feature

(71) Applicant: Peak Degrees Holdings LLC, Trophy Club, TX (US)

(72) Inventor: Christopher Pesek, Trophy Club, TX (US)

(21) Appl. No.: 18/999,862

(22) Filed: Dec. 23, 2024

Related U.S. Application Data
(63) Continuation-in-part of application No. 18/418,072, filed on Jan. 19, 2024.
(60) Provisional application No. 63/614,809, filed on Dec. 26, 2023.

(51) Int. Cl. B25J 1/02

(52) U.S. Cl. CPC B25J 1/02

(57) ABSTRACT

A grabber tool enables a user to grab objects, and particularly obstructed objects. The grabber tool includes a handle mechanism, an elongate arm portion, and a pincher mechanism. The handle mechanism is configured to be ergonomically received in a user's hand and includes a trigger mechanism configured to enable at least a portion of the user's hand to selectively direct the trigger mechanism. The elongate arm portion extends distally from the handle mechanism and includes at least one bendable portion. The pincher mechanism operably extends distally from the elongate arm portion and is operatively coupled to the trigger mechanism. The trigger mechanism is operable to selectively close and open the pincher mechanism via the bendable portion. In some applications, the grabber tool may further include an arm support arrangement configured to engage a user's forearm for countering a pincher mechanism load at the user's forearm.

### PRIOR HISTORY

This application claims the benefit of U.S. Provisional Patent Application No. 63/614,809 filed in the United States Patent and Trademark Office on 26 Dec. 2023 and U.S. patent application Ser. No. 18/418,072 filed in the United States Patent and Trademark Office on 19 Jan. 2024. The specifications and illustrative support for both these applications are hereby incorporated by reference.

### FIELD OF THE INVENTION

The presently disclosed subject matter generally relates to a reaching aid, and more particularly to a grabber tool with a bendable portion for enabling users to reach and/or grab objects at a distance relative to the users. In some embodiments, the grabber tool may comprise an arm support arrangement for counterbalancing loads associated with the load-bearing distal end of the grabber tool.

### BRIEF DESCRIPTION OF THE PRIOR ART

Grabber or reacher tools are known in the art and generally known as reaching aids. Other commonly used descriptors for the devices or tools are grabber reacher aids, trash grabbers, trash picker tools, plier tools, and the like. Such devices generally include a distal arm end that is substantially linear and rigid to bear and transfer the load or weight of the target object into the proximal handle end so that the user can bring the object closer to his or her person to manually engage the reached/grabbed object. The prior art perceives a need for a grabber or reacher tool configured to provide a bendable portion for enabling the user to grab hard-to-reach, obstructed objects. In some embodiments, the entire length of the elongate grabber tool may be bendable and, in some embodiments, the distal arm end may be bendable. The presently disclosed subject matter attempts to provide such a solution as summarized in more detail hereinafter.

### SUMMARY OF THE INVENTION

The presently disclosed subject matter provides a grabber tool for generally enabling a user to grab objects in a manner akin to those briefly described above. As prefaced above, similar tools are known in the art, and are commonly referred to as grabber tools or reacher tools, The distal ends of these types of grabber tools are generally outfitted with some type of pincher mechanism that is operable to pinch or grab an object so that the user may then reorient the tool and bring the grabbed object closer to the user's person without the need to bend, stand, reach, or climb upon secondary support structures to reach the targeted object.

As further prefaced above, state-of-the-art tools of this type are typically configured such that the distal arm end of the grabber tool is linear and substantially rigid to bear and transfer the weight of the object(s) so grabbed into the user's hand. Target objects, however, may be obstructed by other objects and a non-linear pathway to the target object may be the only pathway available. In some embodiments, the grabber tool according to the presently disclosed subject matter provides a distal end configured to be bendable into a non-linear arrangement to help users reach obstructed target objects. In some embodiments, the entire length of the elongate grabber tool may be bendable.

In certain embodiments, the presently disclosed subject matter may be said to essentially teach or disclose a grabber tool for enabling a user to grab objects. The grabber tool according to the presently disclosed subject matter comprises a handle mechanism, and elongate arm portion, and a pincher mechanism. The handle mechanism is configured to be ergonomically received in a user's hand and comprises an upper handle portion, a lower handle portion angled relative to the upper handle portion, and a trigger mechanism.

The elongate arm portion extends from a first handle end of the upper handle portion and comprises a proximal handle end and a distal pincher end. The pincher mechanism operably extends from the distal pincher end and is operatively coupled to the trigger mechanism via a force-transmitting mechanism as exemplified by a cable. The trigger mechanism is operable to selectively open and close the pincher mechanism via the force-transmitting mechanism. In some embodiments, the distal pincher end is configured to be bendable into either a linear arrangement or a non-linear arrangement. In some embodiments, the entire elongate portion is bendable into either a linear arrangement or a non-linear arrangement.

In some embodiments, the elongate portion of the grabber tool may comprise or be outfitted with a pivot mechanism. The optional pivot mechanism enables the user to pivot the distal pincher end relative to the proximal handle end and collapse the grabber tool into a more compact or stowage configuration. In some embodiments, the pivot mechanism may comprise a loop member that extends outwardly from an outer surface thereof for enabling a user to support the grabber tool upon a hook member for storage. In some embodiments, the pivot mechanism may comprise opposed end-receiving portions extending from a centralized pivot mechanism, which end portions mate with distal and proximal arm portions of the elongate arm portion.

In some embodiments, the grabber tool may further comprise an arm support mechanism. The arm support mechanism may comprise a handle mating portion and the handle mechanism may comprise a support mating portion. The handle and support mating portions are matable in these embodiments for attaching the arm support mechanism to the handle mechanism. In some embodiment, the support mating portion is configured to receive the handle mating portion. In some embodiments, the handle and support mating portions each comprise at least one fastener-receiving aperture for receiving at least one fastener for fastening the arm support mechanism to the handle mechanism.

In some embodiments, the arm support mechanism is S-shaped in three dimensions and comprises an arm-engaging angled portion and a support-to-handle angled portion. In some embodiments, the arm-engaging angled portion extends in a first plane and the support-to-handle portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-handle angled portion comprises a first angle segment, a second angle segment and a radiused angle segment extending intermediate the first and second angle segments, the first and second angle segments being angled 30 degrees with respect to one another. In some embodiments, the support-to-handle angled portion is connected to the arm support angled portion by way of a radiused central segment.

There is provided in accordance with another embodiment of the presently disclosed subject matter a grabber tool for enabling a user to grab objects. The grabber tool comprises a handle mechanism configured to be ergonomically received in a user's hand. The handle mechanism comprises a trigger mechanism configured to enable at least a portion of the user's hand to selectively direct at least a portion of the trigger mechanism in a first direction. The grabber tool further comprises an elongate arm portion. The elongate arm portion extends from the handle mechanism in a direction away from the first direction and in some embodiments, comprises a bendable distal end connected to a pincher mechanism. In some embodiments, the entire elongate portion is bendable.

The pincher mechanism operably extends from the distal end of the elongate arm portion. The pincher mechanism is operatively coupled to the trigger mechanism, the trigger mechanism being operable to selectively close the pincher mechanism. In some embodiments, the grabber tool further includes an arm support mechanism. The arm support mechanism extends from the handle mechanism opposite the elongate arm portion for providing a fulcrum point at the handle mechanism and is configured to engage a user's forearm for providing static equilibrium and countering a grabbed object load at the user's forearm.

In some embodiments, the elongate arm portion may comprise a pivot mechanism, the pivot mechanism for enabling the user to pivot a distal arm portion relative to a proximal arm portion of the elongate arm portion to collapse the grabber tool into a more compact configuration. In some embodiments, the pivot mechanism may comprise a loop member that extends outwardly therefrom for enabling a user to support the grabber tool upon a hook member for storage.

In some embodiments, the arm support mechanism may comprise a handle mating portion and the handle mechanism may comprise a support mating portion. The handle and support mating portions are matable in these embodiments for attaching the arm support mechanism to the handle mechanism. In some embodiment, the support mating portion is configured to receive the handle mating portion. In some embodiments, the handle and support mating portions each comprise at least one fastener-receiving aperture for receiving at least one fastener for fastening the arm support mechanism to the handle mechanism.

In some embodiments, the arm support mechanism is S-shaped in three dimensions and comprises an arm-engaging angled portion and a support-to-handle angled portion. In some embodiments, the arm-engaging angled portion extends in a first plane and the support-to-handle portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-handle angled portion comprises a first angle segment, a second angle segment and a radiused angle segment extending intermediate the first and second angle segments, the first and second angle segments being angled 30 degrees with respect to one another. In some embodiments, the support-to-handle angled portion is connected to the arm support angled portion by way of a radiused central segment.

There is provided in accordance with another embodiment of the presently disclosed subject matter a grabber tool for enabling a user to grab objects. The grabber tool may be said to essentially comprise a handle mechanism, an elongate arm portion, and a pincher mechanism. In some embodiments, the handle mechanism is configured to be ergonomically received in a user's hand, and comprises a trigger mechanism configured to enable at least a portion of the user's hand to selectively direct the trigger mechanism. The elongate arm portion extends distally from the handle mechanism and comprises a bendable portion. The pincher mechanism operably extends distally from the elongate arm portion and is operatively coupled to the trigger mechanism. The trigger mechanism is operable to selectively close and open the pincher mechanism via the bendable portion.

In some embodiments, the handle mechanism comprises an upper handle portion and a lower handle portion obliquely angled relative to the upper handle portion. In some embodiments, the trigger mechanism may extend intermediate the upper handle portion and the lower handle portion and be directable toward and away from the lower handle portion. In some embodiments, the elongate arm portion may comprise a pivot mechanism, the pivot mechanism for enabling the user to pivot the pincher mechanism relative to the handle mechanism and direct the grabber tool into a collapsed configuration.

In some embodiments, the grabber tool may further comprise an arm support arrangement extending proximally from the handle mechanism opposite the pincher mechanism. The arm support arrangement according to the presently disclosed subject matter provides a fulcrum point at the handle mechanism in some embodiments. The arm support arrangement may be configured to proximally engage a user's forearm for countering a pincher mechanism load at the user's forearm for relieving strain at the user's hand. In some embodiments, the arm support arrangement is S-shaped in three dimensions and comprises an arm-engaging angled portion and a support-to-handle angled portion.

In some embodiments, the arm support arrangement comprises a tubular body having at least three bends, which bends cooperate to orient a forearm axis of the user's forearm toward the pincher mechanism. In some embodiments, the arm-engaging angled portion extends in a first plane and the support-to-handle portion extends in a second plane, which first and second planes being angled relative to one another. In some embodiments, the first plane extends obliquely relative to the forearm axis such that the first plane extends through a grip end of the handle mechanism.

In some embodiments, the arm-engaging angled portion comprises a first support segment, a second support segment and a radiused support segment extending intermediate the first and second support segments, the radiused support segment being configured for engaging the user's forearm. In some embodiments, the first and second support segments flank outer portions of the user's forearm for further engaging the user's forearm and increasing the support function of the arm-engaging angled portion.

There is provided in accordance with another embodiment of the presently disclosed subject matter a grabber tool for enabling a user to grab obstructed objects. In some embodiments, the grabber tool may be said to essentially comprise a handle mechanism, an elongate arm portion, and a pincher mechanism. The elongate arm portion extends from the handle mechanism and comprises a bendable portion configurable into a bent configuration for grabbing an obstructed object. The pincher mechanism extends from the elongate arm portion and is operatively coupled to the handle mechanism. At least a portion of the handle mechanism is directable to close and open the pincher mechanism via the bendable portion.

In some embodiments, the handle mechanism comprises a hand-operable trigger mechanism, an upper handle portion and a lower handle portion obliquely angled relative to the upper handle portion. In some embodiments, the hand-operable trigger mechanism extends intermediate the upper handle portion and the lower handle portion and is directable toward and away from the lower handle portion for opening and closing the pincher mechanism. In some embodiments, the elongate arm portion may comprise a pivot mechanism. In some embodiments, the pivot mechanism enables the user to pivot the pincher mechanism relative to the handle mechanism and direct the grabber tool into a collapsed configuration.

In some embodiments, the grabber tool may further comprise an arm support arrangement extending proximally from the handle mechanism opposite the pincher mechanism for providing a fulcrum point at the handle mechanism. In some embodiments, the arm support arrangement is configured to engage a user's forearm for countering a pincher mechanism load. In some embodiments, the arm support arrangement is S-shaped in three dimensions and comprises an arm-engaging angled portion and a support-to-handle angled portion. In some embodiments, the arm support arrangement comprises a tubular body having at least three bends, which bends cooperate to orient a forearm axis of the user's forearm toward the pincher mechanism.

In some embodiments, the arm-engaging angled portion extends in a first plane and the support-to-handle portion extends in a second plane, the first and second planes being angled relative to one another. In some embodiments, the first plane extends obliquely relative to the forearm axis such that the first plane extends through the handle mechanism. In some embodiments, the arm-engaging angled portion comprises a first support segment, a second support segment and a radiused support segment extending intermediate the first and second support segments, the radiused support segment being configured for engaging the user's forearm. In some embodiments, the first and second support segments flank outer portions of the user's forearm for further engaging the user's forearm and increasing the support function of the arm-engaging angled portion.

### BRIEF DESCRIPTION OF THE DRAWINGS

Other features and objectives of the presently disclosed subject matter will become more evident from a consideration of the following brief descriptions of patent drawings.

FIG. 1 is a top perspective view of a first grabber tool according to the presently disclosed subject matter showing the first grabber tool in an extended, linear configuration with a relatively large pincher mechanism at a distal end of the grabber tool.

FIG. 2 is a top perspective view of the first grabber tool according to the presently disclosed subject matter showing the first grabber tool in an extended, bent configuration.

FIG. 3 is a top plan view of the first grabber tool according to the presently disclosed subject matter showing the first grabber tool in the extended, linear configuration such that a main tool axis of the grabber tool is in line with a phantom object shown in broken lining and juxtaposed adjacent a box obstruction with a target object shown in solid lining.

FIG. 4 is a top plan view of the first grabber tool according to the presently disclosed subject matter showing the first grabber tool in the extended, bent configuration juxtaposed adjacent the box obstruction otherwise depicted in FIG. 3 to grab the box-obstructed target object.

FIG. 5 is a bottom plan view of the first grabber tool according to the presently disclosed subject matter showing the first grabber tool in the extended, bent configuration.

FIG. 6 is a first lateral side view of the first grabber tool according to the presently disclosed subject matter showing the first grabber tool in the extended, bent configuration.

FIG. 7 is a second lateral side view of the first grabber tool according to the presently disclosed subject matter showing the first grabber tool in the extended, bent configuration.

FIG. 8 is a handle end view of the first grabber tool according to the presently disclosed subject matter showing the first grabber tool in the extended, bent configuration.

FIG. 9 is a pincher end view of the first grabber tool according to the presently disclosed subject matter showing the first grabber tool in the extended, bent configuration.

FIG. 10 is a top perspective view of a second grabber tool according to the presently disclosed subject matter showing the second grabber tool in an extended, linear configuration with a relatively small pincher mechanism at a distal end of the grabber tool.

FIG. 11 is a top perspective view of the second grabber tool according to the presently disclosed subject matter showing the second grabber tool in an extended, bent configuration.

FIG. 12 is a top plan view of the second grabber tool according to the presently disclosed subject matter showing the second grabber tool in the extended, linear configuration.

FIG. 13 is a top plan view of the second grabber tool according to the presently disclosed subject matter showing the second grabber tool in the extended, bent configuration.

FIG. 14 is a top perspective view of bendable arm portions of the first and second grabber tools in the bent configuration and outfitted with the relatively large and relatively small pincher mechanisms and positioned side-by-side to one another for comparison purposes.

FIG. 15 is a top plan view of the bendable arm portions of the first and second grabber tools in the bent configuration and outfitted with the relatively large and relatively small pincher mechanisms and positioned side-by-side to one another for comparison purposes.

FIG. 16 is a top perspective view of the first grabber tool according to the presently disclosed subject matter showing the first grabber tool in a collapsed configuration.

FIG. 17 is a top plan view of the first grabber tool according to the presently disclosed subject matter showing the first grabber tool in the collapsed configuration.

FIG. 18 is a lateral side view of the first grabber tool according to the presently disclosed subject matter showing the first grabber tool in the collapsed configuration.

FIG. 19 is a bottom plan view of the first grabber tool according to the presently disclosed subject matter showing the first grabber tool in the collapsed configuration.

FIG. 20 is a first end view of the first grabber tool according to the presently disclosed subject matter showing the first grabber tool in the collapsed configuration.

FIG. 21 is a second end view of the first grabber tool according to the presently disclosed subject matter showing the first grabber tool in the collapsed configuration.

FIG. 22 is an enlarged distal end view of an elongate arm portion of the grabber tool according to the presently disclosed subject matter and depicting a pivot axis of rotation extending through a pivot mechanism on the elongate arm portion.

FIG. 23 is an enlarged, lateral side view of the handle mechanism of the grabber tool according to the presently disclosed subject matter.

FIG. 24 is an enlarged, bottom perspective view of a handle mechanism of the grabber tool with arm support arrangement according to the presently disclosed subject matter showing a trigger mechanism and arm support-mating structure thereof.

FIG. 25 is an enlarged, distal end view of the handle mechanism of the grabber tool according to the presently disclosed subject matter.

FIG. 26 is an enlarged lateral side view of a pincher mechanism of the grabber tool according to the presently disclosed subject matter.

FIG. 27 is an enlarged top plan view of the pincher mechanism of the grabber tool according to the presently disclosed subject matter depicting the pincher mechanism being operated to pinch or grab a generic object.

FIG. 28 is an enlarged top plan view of the pincher mechanism of the grabber tool according to the presently disclosed subject matter depicting the pincher mechanism being operated to release the generic object.

FIG. 29 is a top perspective view of the first grabber tool with an arm support arrangement according to the presently disclosed subject matter showing the first grabber tool with arm support arrangement in the extended, linear configuration.

FIG. 30 is a top perspective view of the first grabber tool with arm support arrangement according to the presently disclosed subject matter showing the first grabber tool with arm support arrangement in the extended, bent configuration.

FIG. 31 is a top plan view of the first grabber tool with arm support arrangement according to the presently disclosed subject matter showing the first grabber tool with arm support arrangement in the extended, linear configuration and positioned adjacent a target object with an object weight being directed into the page and a balancing force at the arm support arrangement being directed out of the page.

FIG. 32 is a top plan view of the first grabber tool with arm support arrangement according to the presently disclosed subject matter showing the first grabber tool with arm support arrangement in the extended, bent configuration and positioned adjacent a target object with an object weight being directed into the page and a balancing force at the arm support arrangement being directed out of the page.

FIG. 33 is a lateral side view of the first grabber tool with arm support arrangement according to the presently disclosed subject matter showing the first grabber tool with arm support arrangement in the extended, linear configuration and in an object-grabbing condition of use with an object weight being directed downwardly and a balancing force at the arm support arrangement being directed upwardly.

FIG. 34 is a lateral side view of the first grabber tool with arm support arrangement according to the presently disclosed subject matter showing the first grabber tool with arm support arrangement in the extended, bent configuration and in an object-grabbing condition of use with an object weight being directed downwardly and a balancing force at the arm support arrangement being directed upwardly.

FIG. 35 is a top perspective view of the second grabber tool with arm support arrangement according to the presently disclosed subject matter showing the second grabber tool with arm support arrangement in the extended, linear configuration.

FIG. 36 is a top perspective view of the second grabber tool with arm support arrangement according to the presently disclosed subject matter showing the second grabber tool with arm support arrangement in the extended, bent configuration.

FIG. 37 is a top plan view of the second grabber tool with arm support arrangement according to the presently disclosed subject matter showing the second grabber tool with arm support arrangement in the extended, linear configuration.

FIG. 38 is a top plan view of the second grabber tool with arm support arrangement according to the presently disclosed subject matter showing the second grabber tool with arm support arrangement in the extended, bent configuration.

FIG. 39 is a proximal end view of the first grabber tool with arm support arrangement according to the presently disclosed subject matter.

FIG. 40 is a first top perspective view of the arm support arrangement usable in combination with the grabber tool according to the presently disclosed subject matter depicting a fragmentary user forearm in positioned placement atop the arm support arrangement to show relative placement of the user forearm relative to the arm support arrangement.

FIG. 41 is a second top perspective view of the arm support arrangement usable in combination with the grabber tool according to the presently disclosed subject matter showing a distal support-to-fulcrum angled portion and a proximal arm-engaging angled portion thereof and depicting the angular relationship of a first support segment relative to a second support segment of the arm-engaging angled portion.

FIG. 42 is a distal end view of the arm support arrangement usable in combination with the grabber tool according to the presently disclosed subject matter.

FIG. 43 is a proximal end view of the arm support arrangement usable in combination with the grabber tool according to the presently disclosed subject matter.

FIG. 44 is a first lateral side view of the arm support arrangement of the grabber tool according to the presently disclosed subject matter depicting the angular relationship of the proximal arm-engaging angled portion relative to the support-to-fulcrum angled portion.

FIG. 45 is a second lateral side view of the arm support arrangement usable in combination with the grabber tool according to the presently disclosed subject matter depicting the angular relationship of the support-to-fulcrum angled portion relative to the arm-engaging angled portion.

FIG. 46 is a perspective view of the arm support arrangement usable in combination with the grabber tool according to the presently disclosed subject matter depicting the angular relationship of a first angle segment relative to a second angle segment of the support-to-fulcrum angled portion.

FIG. 47 is a lateral side view of an alternative handle mechanism attached to the arm support arrangement with a fragmentary elongate arm portion depicting a diagrammatic load directed downwardly at the distal end thereof and a balancing force being depicted directed upwardly at the arm support arrangement.

FIG. 48 is a top plan view of the alternative handle mechanism attached to the arm support arrangement with the fragmentary elongate arm portion depicting a diagrammatic load directed into the page at the distal end thereof and the balancing force being depicted directed out of the page at the arm support arrangement.

### DETAILED DESCRIPTION OF THE EMBODIMENTS

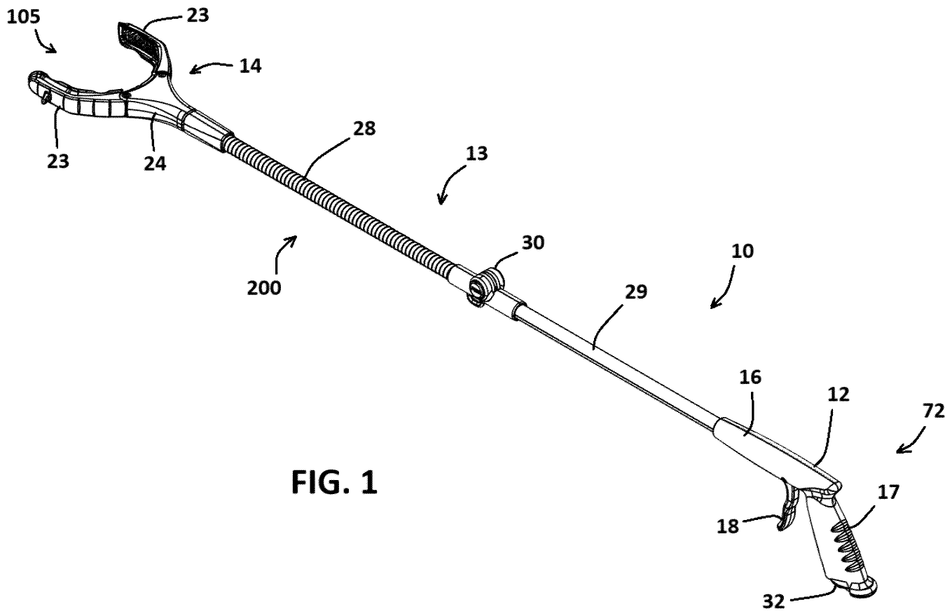

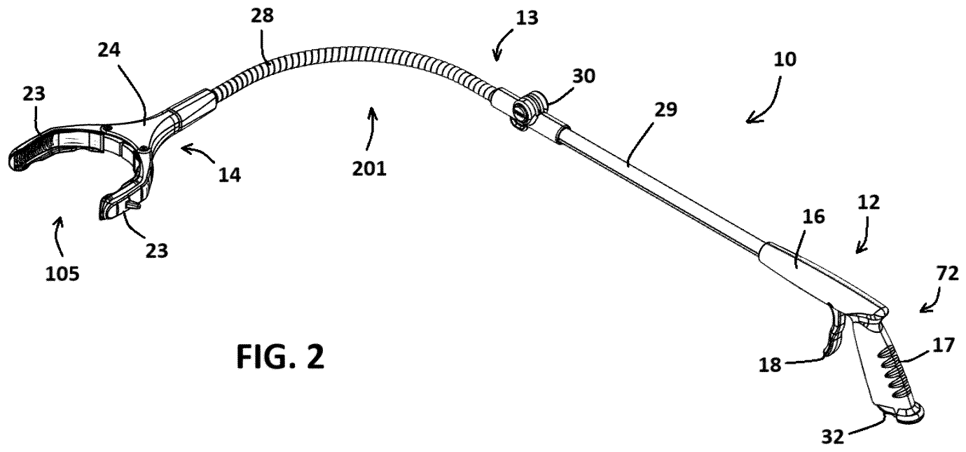

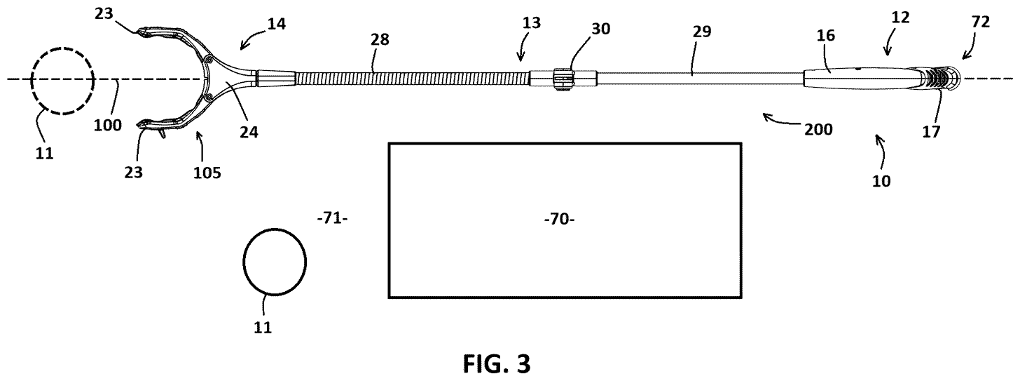

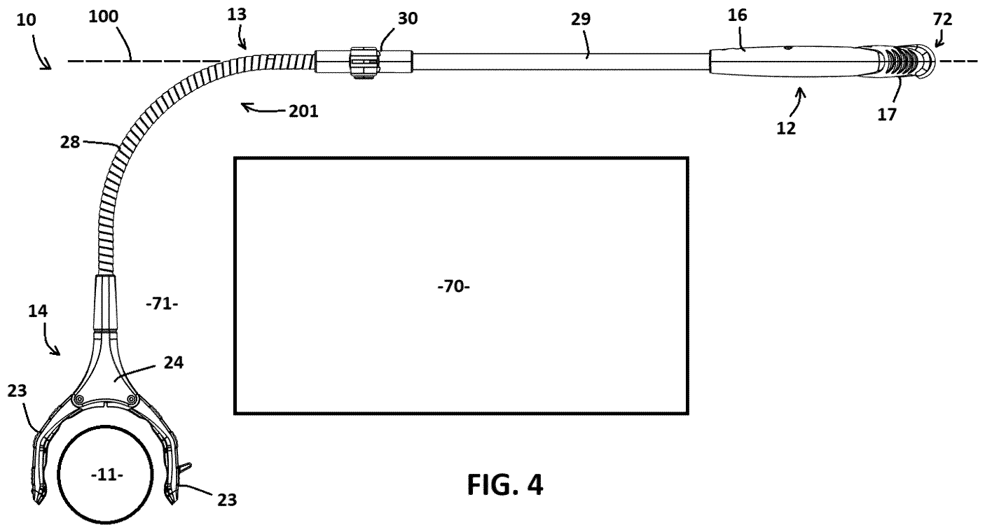

Referring now to the drawings with more specificity, the presently disclosed subject matter provides a grabber tool 10 for enabling a user to grab objects from a distance greater than a user's natural arm length. The grabber tool 10 is reconfigurable in either a linear configuration 200 as generally depicted and introduced in FIGS. 1 and 3 or a bent configuration 201 as generally depicted and introduced in FIGS. 2 and 4. When in the linear configuration 200, the grabber tool 10 extends along a main tool axis 100. When in the bent configuration 201, a bendable arm portion 13 of the grabber tool 10 is bent away from the main tool axis 100. A generic, cylindrically shaped target object is introduced and referenced at 11 in FIGS. 3 and 4. The linear configuration 200 depicted in FIG. 3 is ill-suited to grab the object 11 given an obstruction as at box 70. The bent configuration 201 depicted in FIG. 4 is better suited to grab the obstructed object 11.

It is noted that similar tools of this type are known in the art, and are commonly referred to as grabber tools, reacher tools, grabber reacher aids, trash grabbers, trash picker tools, plier tools, and the like. The distal ends of these types of elongate grabber tools are generally outfitted with a hand-operable pincher mechanism that may pinch or grab an object so that the user may then reorient the tool and bring the grabbed object closer to the user's person without the need to bend, stand, reach, or climb upon secondary support structures to reach the targeted object. These tools, however, are not reconfigurable into either a linear configuration or a bent configuration. These tools typically provide for a linear configuration only and when a target object is obstructed, the tools can prevent or render difficult access to the target object.

In this regard, a direct line or linear access to a target object 11 may not always be available. In other words, in some situations, the user may wish to grab an obstructed object with a grabber tool. In this regard, the reader is directed to FIGS. 3 and 4 comparatively depicting an object 11 shown in solid lining located in a space 71 obstructed from a handle end 72 of the grabber tool 10. For ease of illustration the obstruction is generically depicted by box 70. The grabber tool 10 according to the presently disclosed subject matter enables the user to reach around obstructions as exemplified by box 70 and grab objects 11 that are not linearly free to access or grab. In this regard, the reader is directed to FIGS. 1 and 3, which depict the grabber tool 10 in an unbent, generally linear configuration 200 for grabbing objects 11 in line with the main tool axis 100 of the grabber tool 10. A phantom object 11 shown in broken lining has been depicted in FIG. 3 in line with the main tool axis 100. Comparatively referencing FIGS. 2 and 4, the reader will there consider the grabber tool 10 in the bent configuration 201, which enables the user to grab objects out of a direct line with the main tool axis 100 of the grabber tool 10.

It is further noted that state-of-the-art tools of this type are typically configured such that the weight 101 of the object 11 so grabbed is directed into the user's hand and radiocarpal joint by way of the elongated arm portion of the tools, thereby placing stress or strain upon the hand and/or radiocarpal joint causing discomfort or possible injury to the user in many instances. In some embodiments, the grabber tool 10 according to the presently disclosed subject matter shifts the moment away from the user's hand, the radiocarpal joint and peripheral anatomy toward the user's arm, which anatomy is better suited to provide static equilibrium with less strain at the user's hand and radiocarpal joint. The shift of the balancing force thereby decreases discomfort at the hand/joint during usage and improving overall stability and usage of the grabber tool 10, particularly for user's who have experienced previous injury to the anatomical areas or users who have experienced a decline in structural strength in these anatomical areas, for example, the elderly.

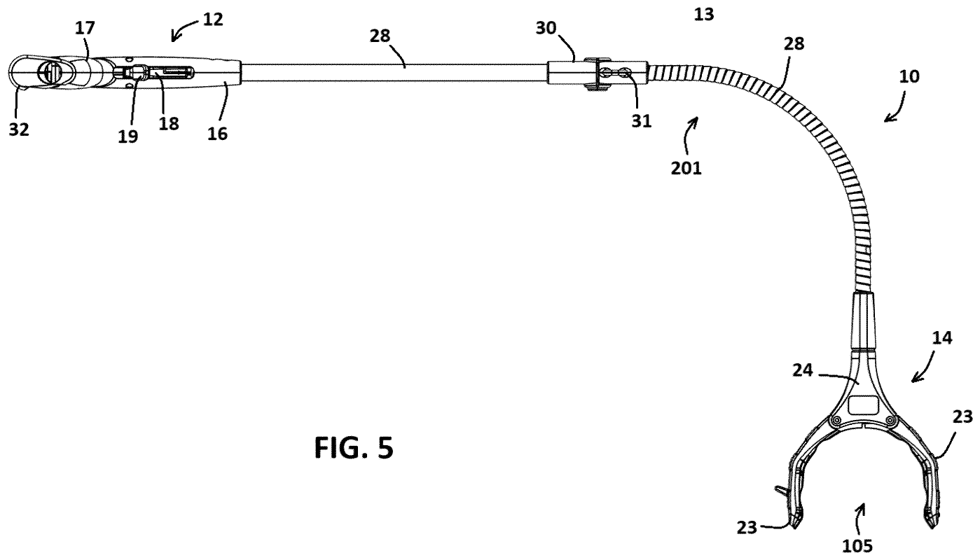

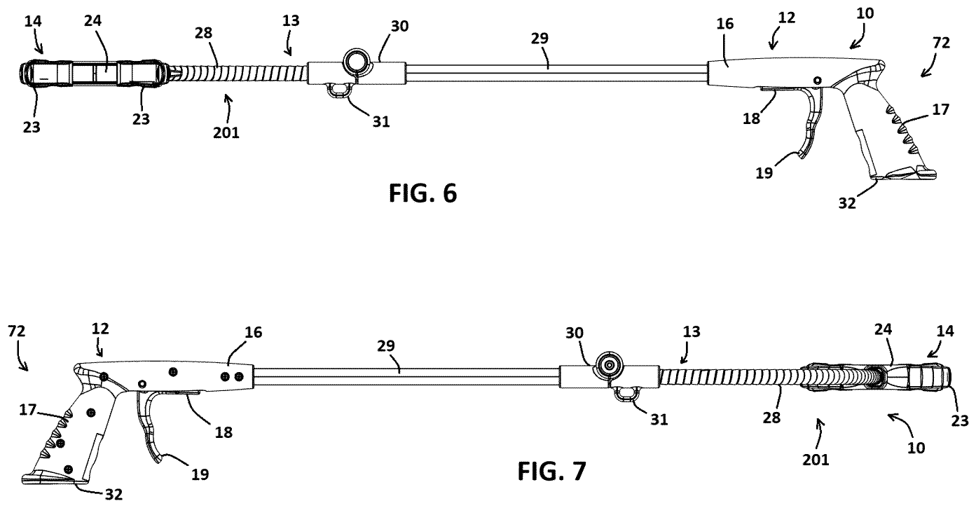

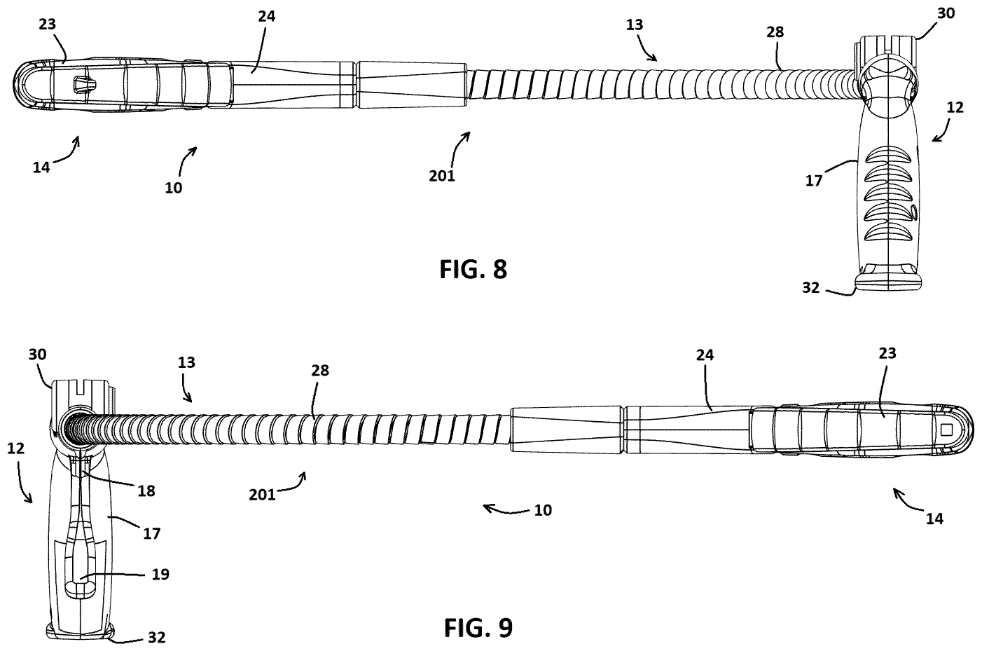

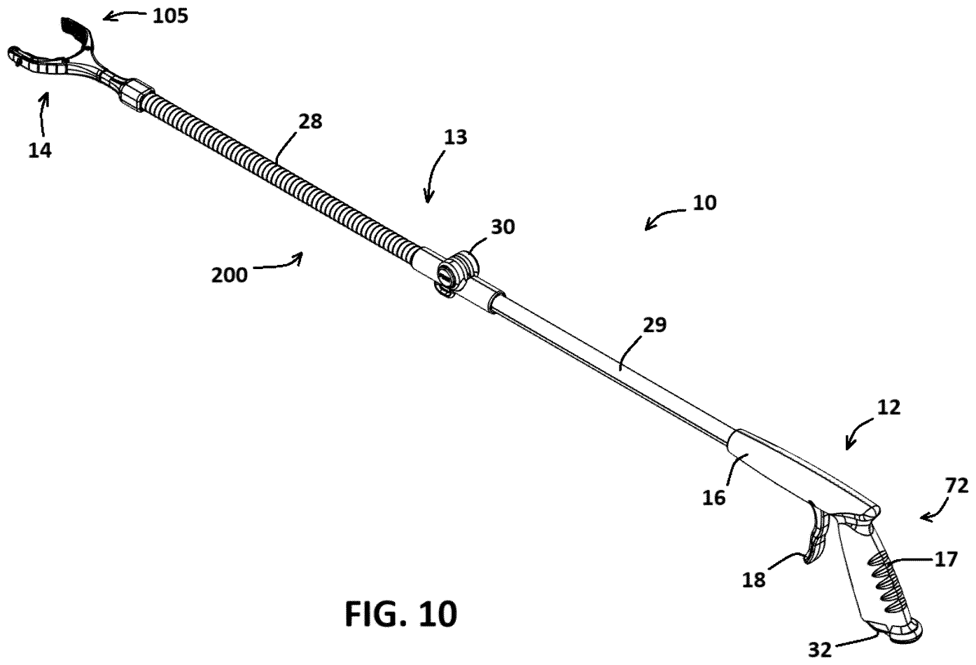

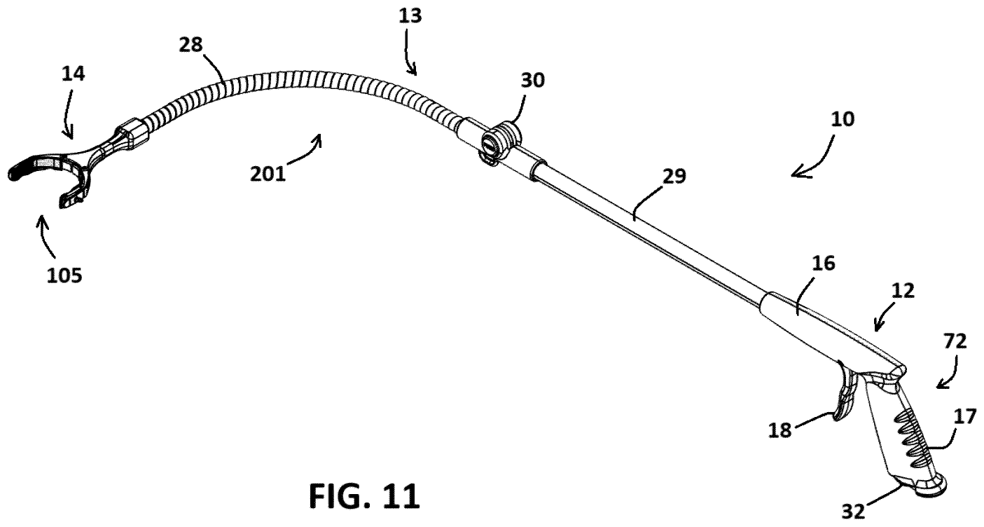

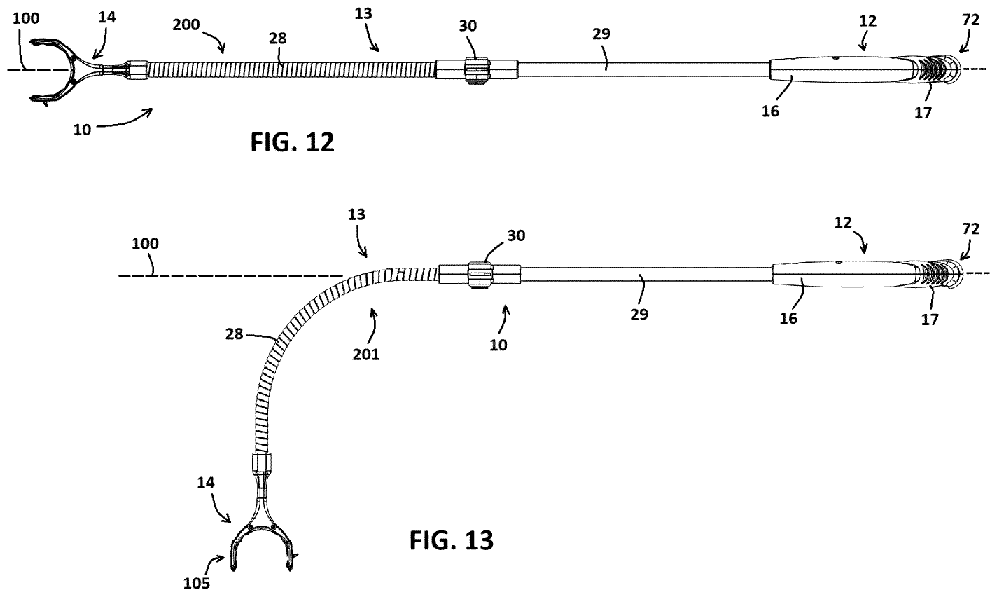

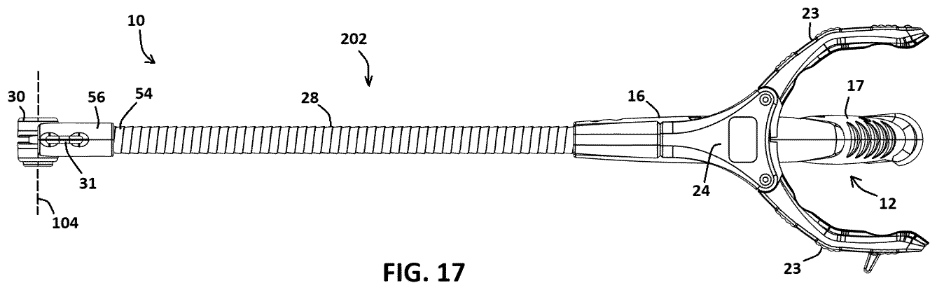

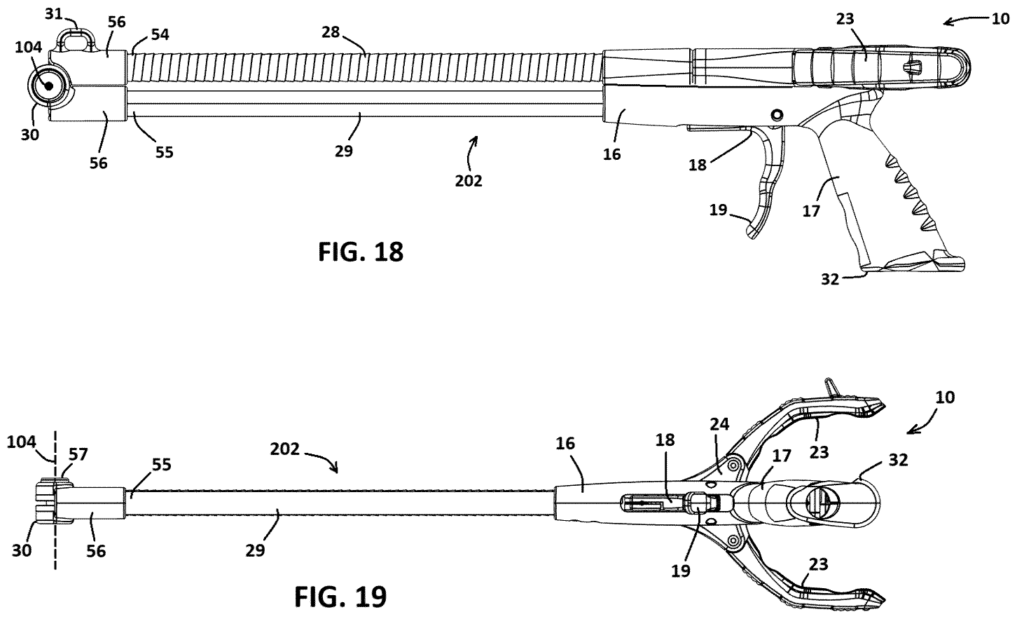

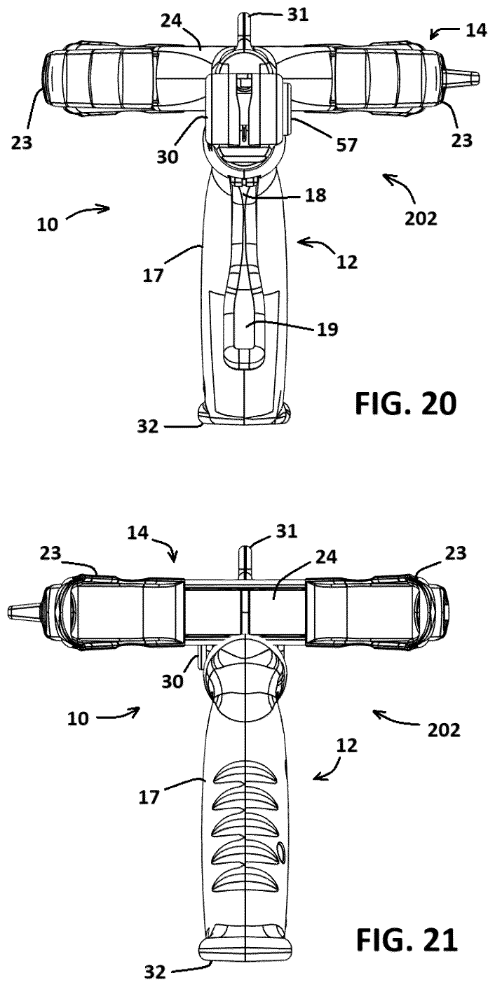

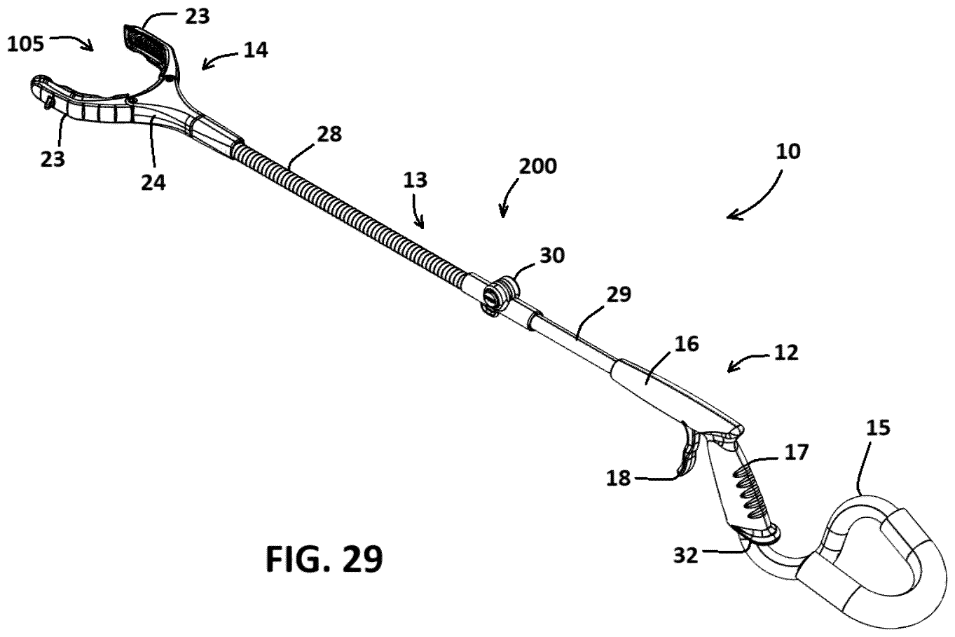

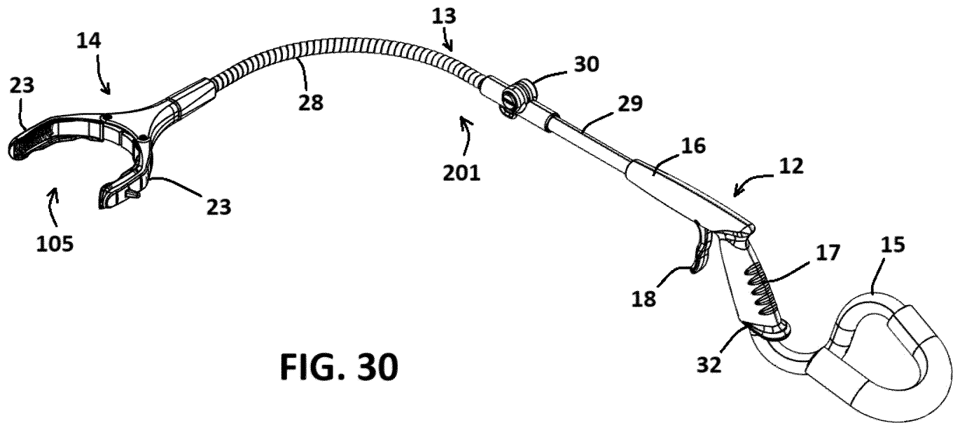

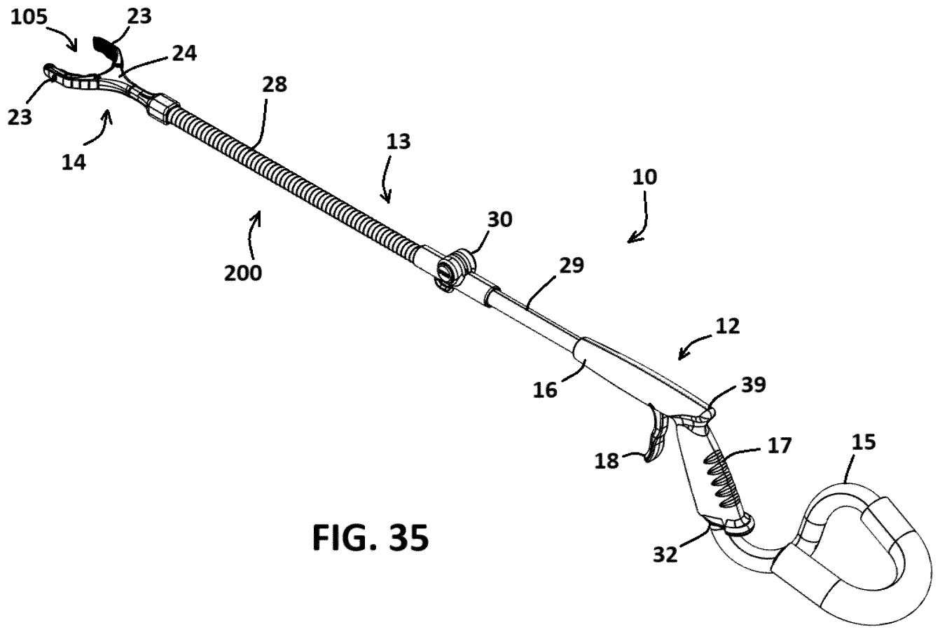

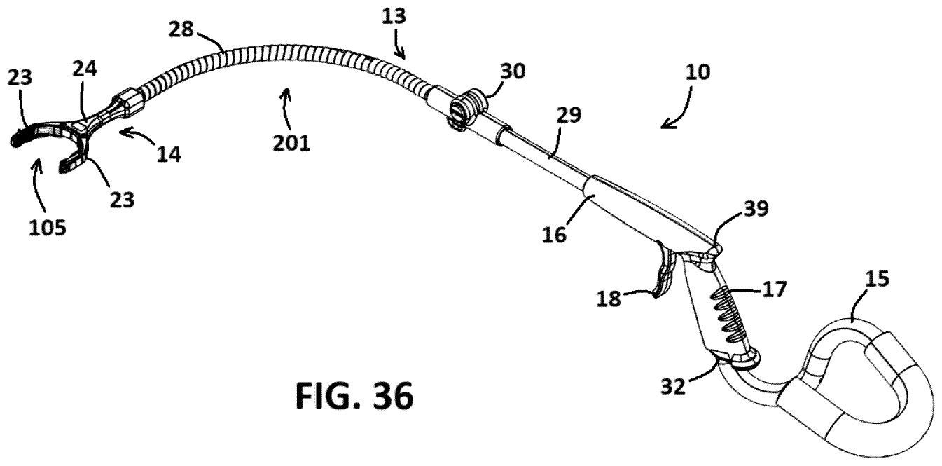

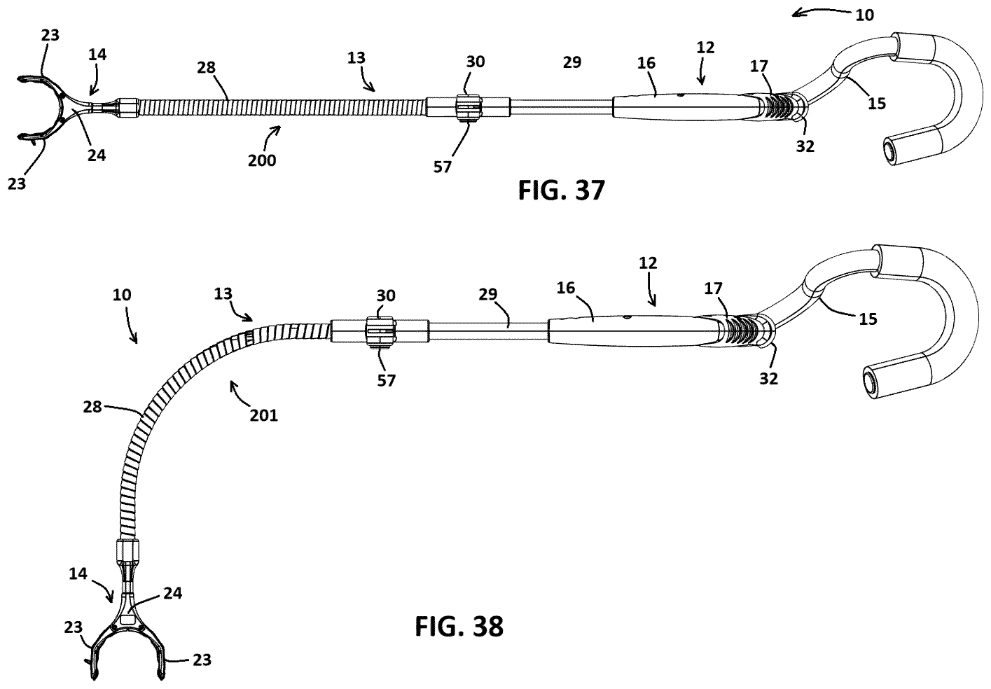

Accordingly, in some embodiments, the grabber tool 10 according to the presently disclosed subject matter may comprise a handle mechanism 12, a distally extending, bendable elongate arm portion 13, and a distally located pincher mechanism 14 opposite the handle end 72. These embodiments are generally depicted in FIGS. 1-13 and 16-21. In other embodiments, the grabber tool 10 may comprise a centrally located handle mechanism 12 and a proximally located arm support arrangement 15 opposite the distally located pincher mechanism 14. These embodiments are generally depicted in FIGS. 29-39.

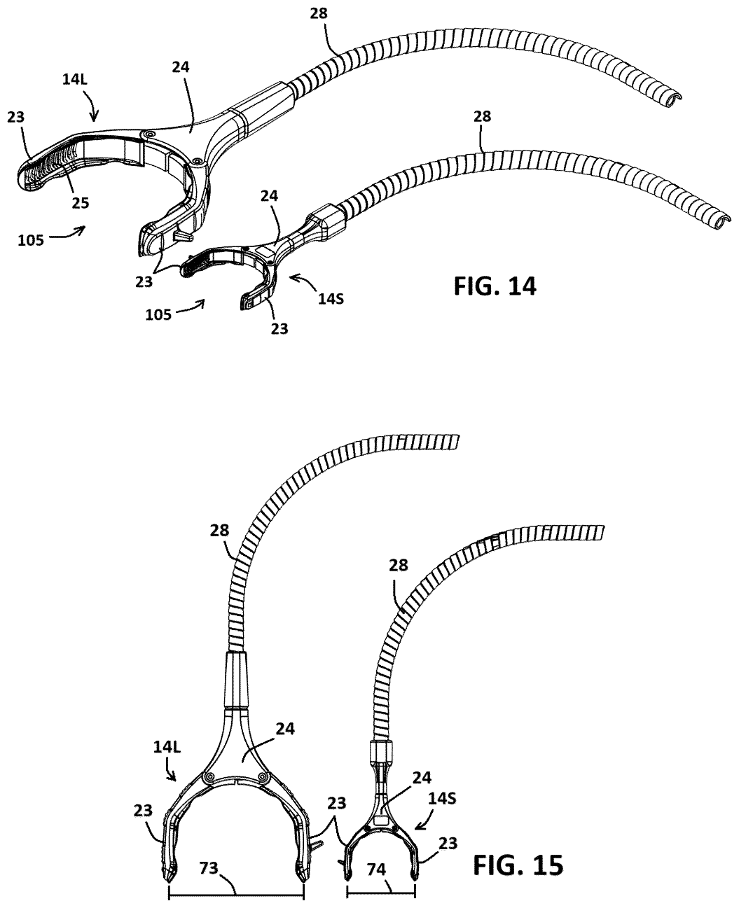

FIGS. 14 and 15 depict alternative pincher mechanisms 14L and 14S for the grabber tool 10. In some embodiments, the alternative pincher mechanisms 14L and 14S are interchangeable and include at least a relatively large pincher mechanism for grabbing relatively larger objects as referenced at 14L and a relatively small pincher mechanism for grabbing relatively smaller objects as referenced at 14S. The relatively large pincher mechanism 14L comprises a large pincher span 73 greater than a small pincher span 74 of the relatively small pincher mechanism 14S as comparatively depicted and referenced in FIG. 15.

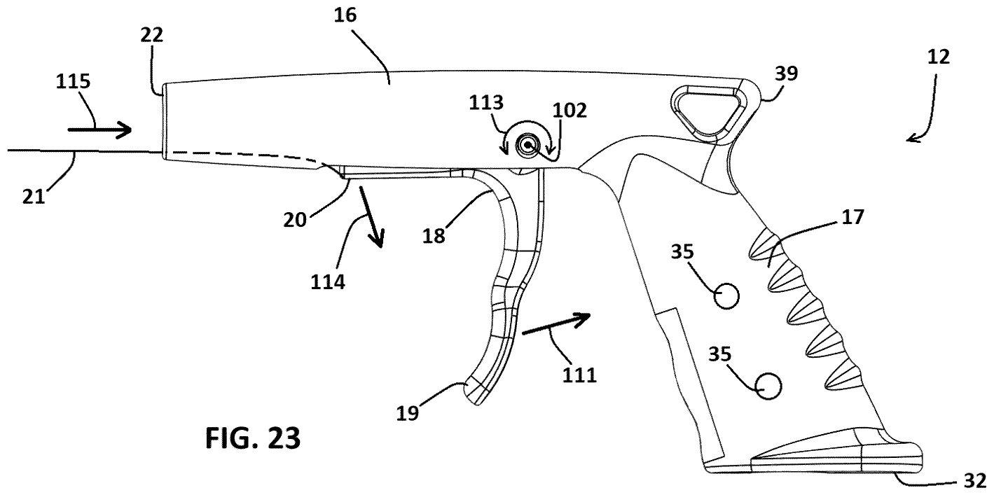

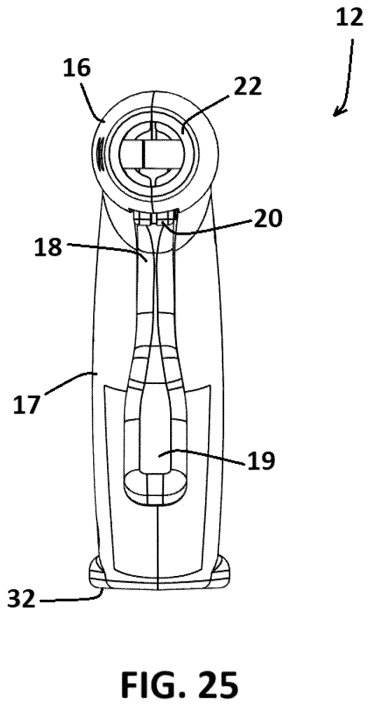

The handle mechanism 12 is particularly depicted in FIGS. 23-25. Whether centrally located relative to the distal pincher mechanism 14 and the proximal arm support arrangement 15 or proximally positioned at the handle end 72, the handle mechanism 12 is configured to be ergonomically received in a user's hand and in some embodiments is generally shaped in much the same manner as a pistol grip. More particularly, the handle mechanism 12 comprises an upper handle or barrel portion as at 16 and a lower handle portion or grip portion 17. In some embodiments, the lower handle portion 17 is angled relative to the upper handle portion 16. The handle mechanism 12 further comprises a trigger mechanism as at 18. The trigger mechanism 18 generally extends intermediate the upper handle portion 16 and the lower handle portion 17 and is configured to enable the user's hand or fingers to selectively direct a trigger portion 19 of the trigger mechanism 18 toward the lower handle portion 17 as generally depicted in FIG. 23.

Referencing FIG. 23, the trigger mechanism 18 is pivotally connected to the upper handle portion 16 and pivots as at 113 about a trigger axis of rotation 102 when the trigger portion 19 is directed as at vector 111 toward the lower handle portion 17. A distal trigger portion 20 of the trigger mechanism 18 is directed as at vector 114 when the trigger portion 19 is directed as at vector 111. The distal trigger portion 20 is connected to a cable 21, which cable 21 extends through the distal arm end 22 of the upper handle portion 16 and through the distally extending elongate arm portion 13 to the distally located pincher mechanism 14. In some embodiments, the grabber tool 10 may comprise a distal arm portion 28 and a proximal arm portion 29. In some embodiments, the proximal arm portion 29 extends from the distal end 22 of the upper handle portion 16.

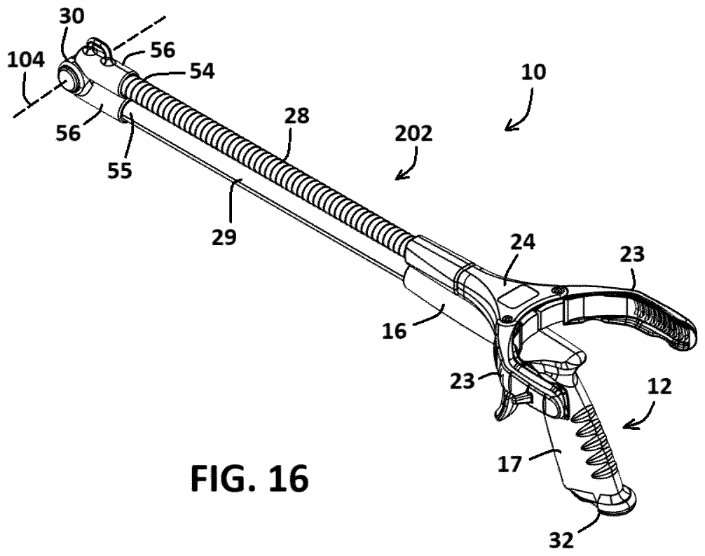

The elongate arm portion 13 preferably comprises at least one bendable portion. In some embodiments, the bendable portion may be formed from metallic bendable hose or flexible metal conduit. In some embodiments, the distal arm portion 28 may comprise the bendable material for providing the bendable portion of the elongate arm portion 13. In some embodiments, the proximal arm portion 29 comprises a substantially rigid material such as a metallic tubular material. In some embodiments, the distal arm portion 28 and the proximal arm portion 29 are interconnected by an optional pivot mechanism 30. The distal arm portion 28 comprises a pivot connector arm end 54 and the proximal arm portion 29 comprises a pivot connector arm end 55. In some embodiments, the pivot connector arm ends 54 and 55 mate with (female) opposed end-receiving portions 56 of the pivot mechanism 30, further optionally outfitted with push button release mechanism 57 in some embodiments. The push button release mechanism 57 is operable to selectively lock the distal arm portion 28 in an extended configuration and unlock the pivot mechanism 30 so as to be able to pivot the distal arm portion 28 relative to the proximal arm portion 29 into a collapsed, stowage configuration 202 as generally depicted in FIGS. 16-21.

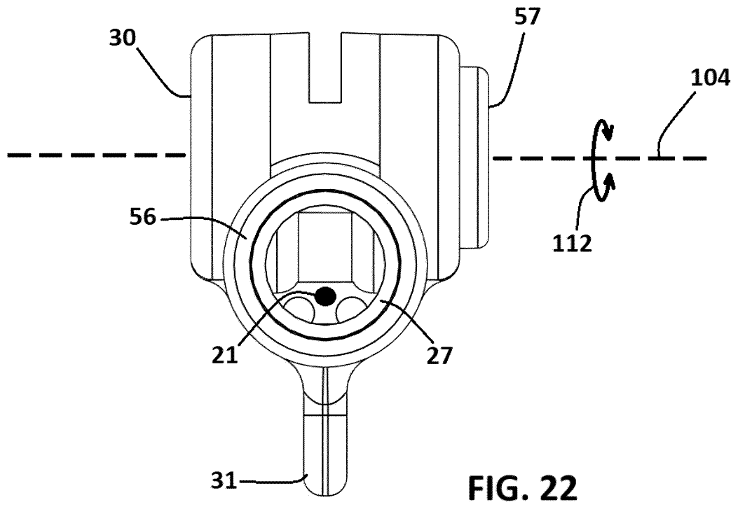

The extended configuration of the grabber tool 10 is generally depicted in FIGS. 1 through 13 and may be compared to the collapsed, stowage configuration 202 generally depicted in FIGS. 16 through 21. FIG. 22 more particularly depicts the optional pivot mechanism 30. The optional pivot mechanism 30 enables the user to rotate as at arrows 112 the distal arm portion 28 and pincher end 27 thereof about an arm axis of rotation 104 or pivot axis relative to the proximal arm portion 29 thereby collapsing the grabber tool 10 into the relatively more compact or shorter stowage configuration 202 as generally depicted in FIGS. 16-21. In some embodiments, the pivot mechanism 30 may further comprise a loop member 31 that extends outwardly therefrom for enabling a user to support or hang the grabber tool 10 upon a hook member or similar other structure for storage.

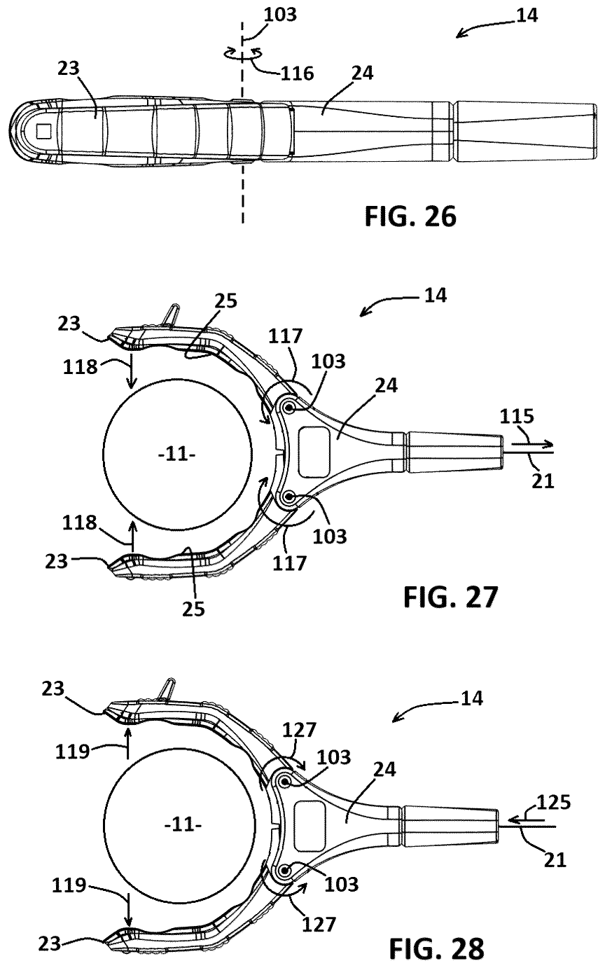

The reader is directed to FIGS. 26-28 in support of the pinching action of the pincher mechanism 14. In some embodiments, the distally located pincher mechanism 14 comprises laterally opposed grabber elements or arms as at 23. The laterally opposed grabber elements 23 are pivotally attached to a main body 24 of the pincher mechanism 14 and are pivotal as at arrows 116 about grabber arm axes of rotation as at 103. When the force-transferring cable 21 is directed as at vector 115 proximally toward the lower handle portion 17 by way of the trigger mechanism 18, the force-transferring cable 21 transfers the user-imparted trigger force 111 into the grabber elements 23 which then rotate as at arrows 117 about the grabber arm axes of rotation as at 103 to pinch or grab the object 11 as at vectors 118 in FIG. 27. In some embodiments, the grabber elements 23 may be inwardly outfitted with pliable, high friction materials and configurations as at 25 to better grip the object 11 as it is grabbed or pinched by the pincher mechanism 14.

In some embodiments, the pincher mechanism 14 may comprise at least one internal spring mechanism (not specifically illustrated) within the main body 24 for returning the grabber elements 23, which then rotate as at arrows 127 about the grabber arm axes of rotation as at 103 to the open position 105 and directing 125 the cable 21 toward the pincher mechanism 14 when the trigger force 111 is removed from the trigger mechanism 18 as generally depicted and referenced in FIG. 28. It will thus be understood the pincher mechanism 14 operably extends from the elongate arm portion 13 and is operatively coupled or connected to the trigger mechanism 18 by way of the force-transferring cable 21. The trigger mechanism 18 essentially functions to selectively close the pincher mechanism 14 for grabbing or pinching an object 11, and when the user releases the trigger portion 19, the grabber elements 23 return to the open position 105 for releasing the object 11 as at arrows 119.

The foregoing descriptions in support of the handle mechanism 12 and the pincher mechanism 14 of the grabber tool 10 are fairly typical of state-of-the-art grabber tools. Central to the practice of the presently disclosed subject matter, and distinct from the state-of-the-art, is the elongate arm portion 13 having at least one bendable portion. In some embodiments, the bendable portion is positioned at the distal arm portion 28. In some embodiments, the elongate arm portion 13 may comprise a bendable material along its entire length or alternatively at the proximal arm portion 29. Further, the arm support arrangement 15 or feature according to the presently disclosed subject matter is also distinctive. The arm support arrangement 15 is attached proximally relative to the handle mechanism 12 in some embodiments opposite the elongate arm portion 13 and the pincher mechanism 14 of the grabber tool 10.

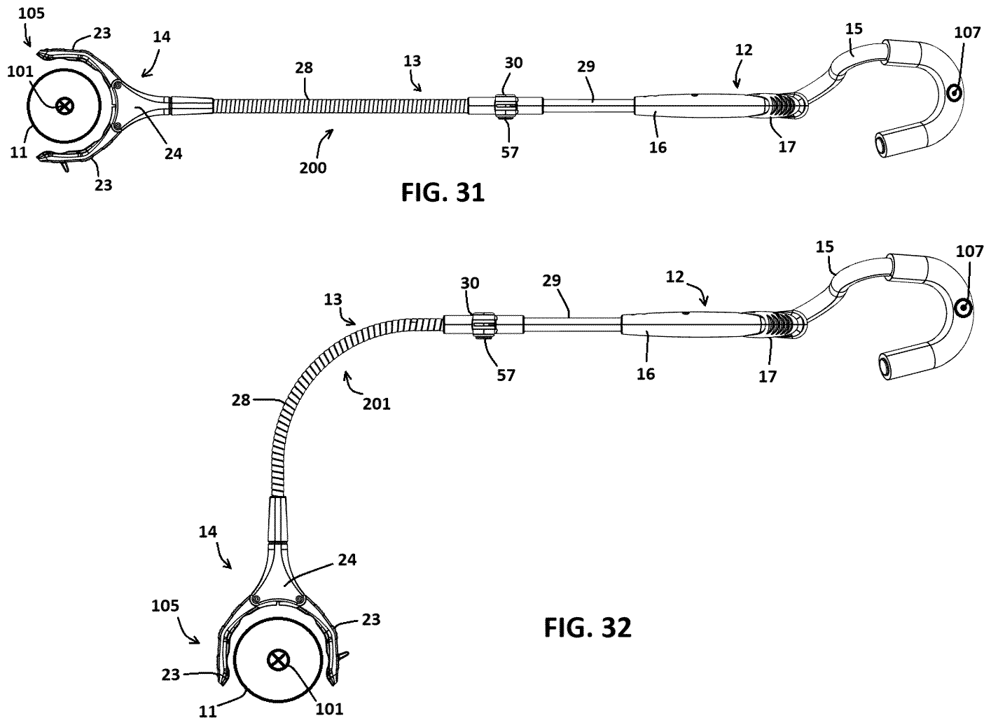

The proximally located arm support arrangement 15 extends from a support end 32 of the lower handle portion 17 opposite the distally extending bendable elongate arm portion 13 for essentially providing a fulcrum point at the handle mechanism 12. In this regard, the proximally located arm support arrangement 15 is configured to engage lower portions of a user's forearm 106 for countering or balancing an object load or weight 101 at the pincher mechanism 14 as diagrammatically depicted in FIGS. 31-34. A fragmentary user forearm 106 is comparatively depicted in FIG. 40. The arm support arrangement 15 provides a structural basis for enabling static equilibrium by way of a directed balancing force 107 equal and opposite to the load or weight 101. The balancing force 107 is directed into the user's forearm 106 in proximally spaced relation to the handle mechanism 12 for relieving anatomical strain at or about the user's hand and radiocarpal joint.

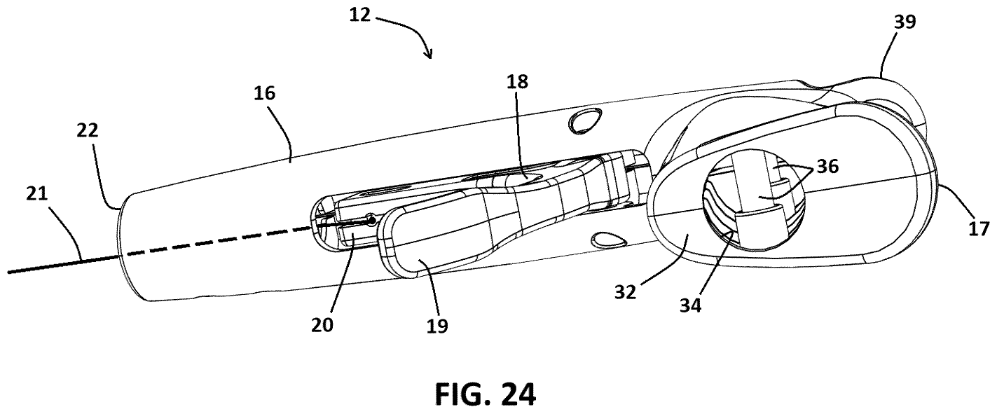

In some embodiments, the proximally located arm support arrangement 15 may further comprise a handle mating portion 33 and the handle mechanism 12 may comprise a support mating portion 34 as referenced in FIG. 24. The handle and support mating portions 33 and 34 are matable for attaching the arm support arrangement 15 to the handle mechanism 12. In some embodiments, a female support mating portion 34 is configured to receive a male handle mating portion 33. In some embodiments, the handle and support mating portions 33 and 34 each comprise at least one fastener-receiving aperture 35 for receiving at least one fastener 36 for fastening the arm support arrangement 15 to the handle mechanism 12.

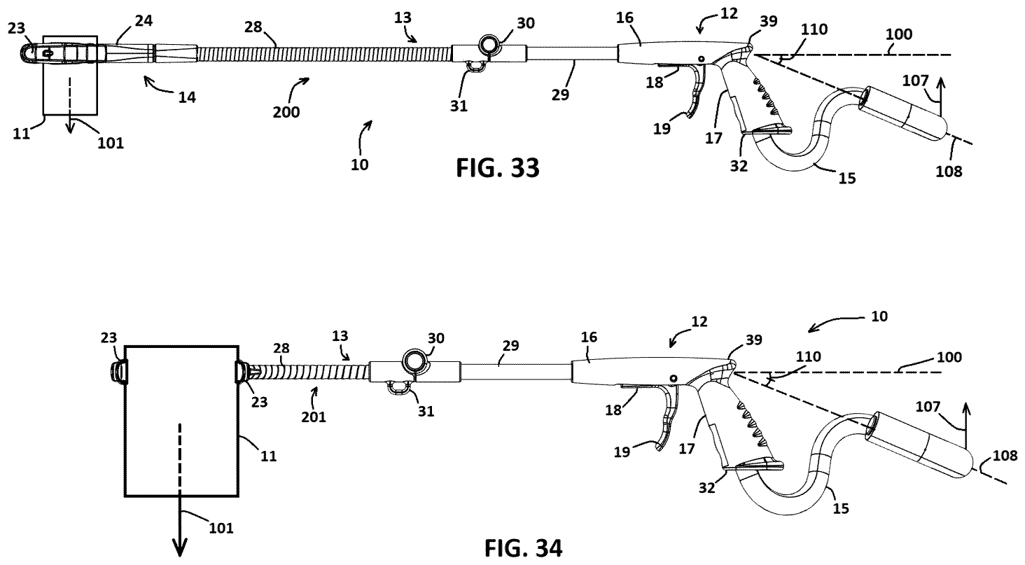

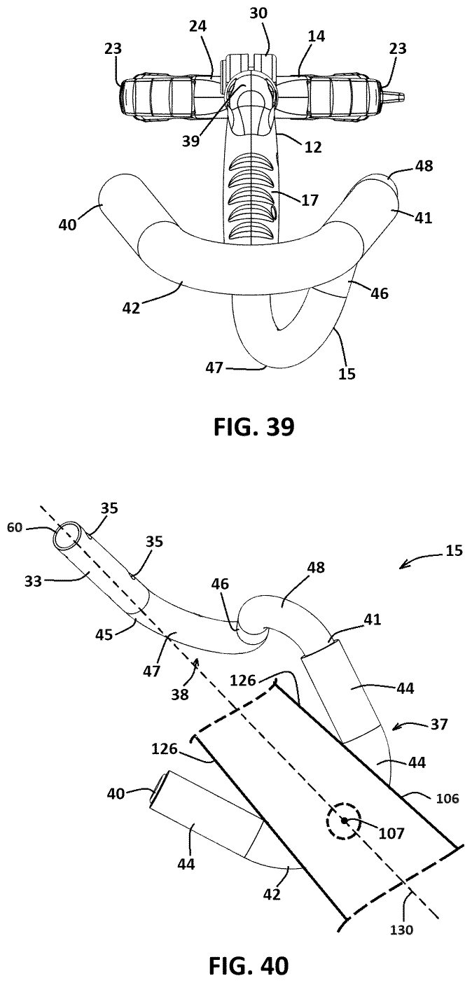

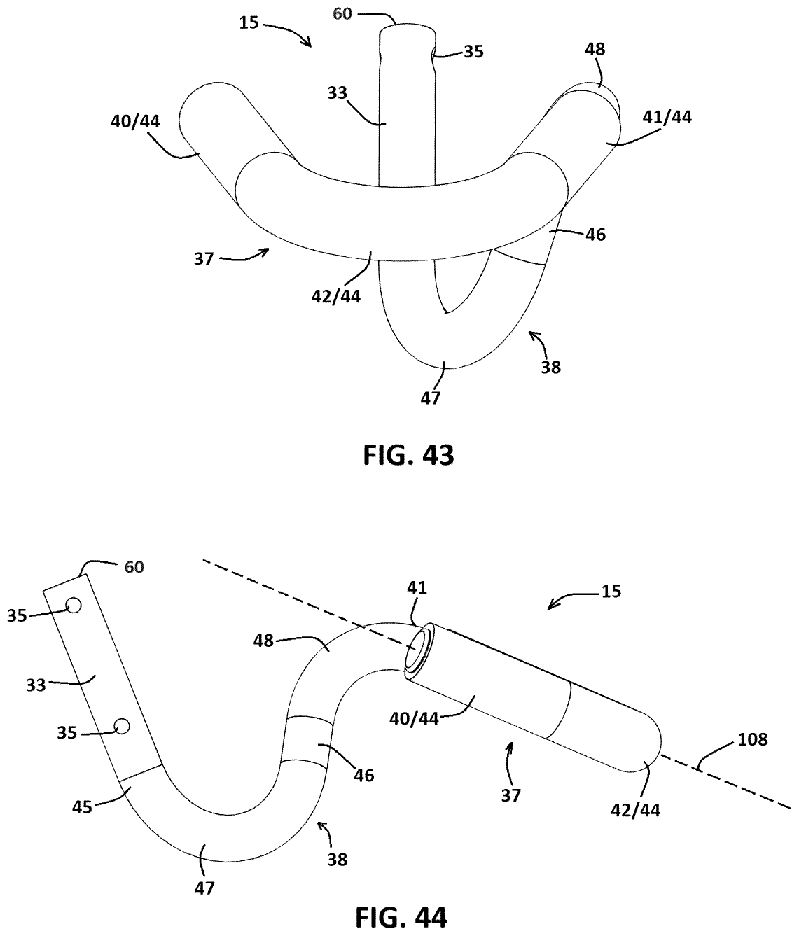

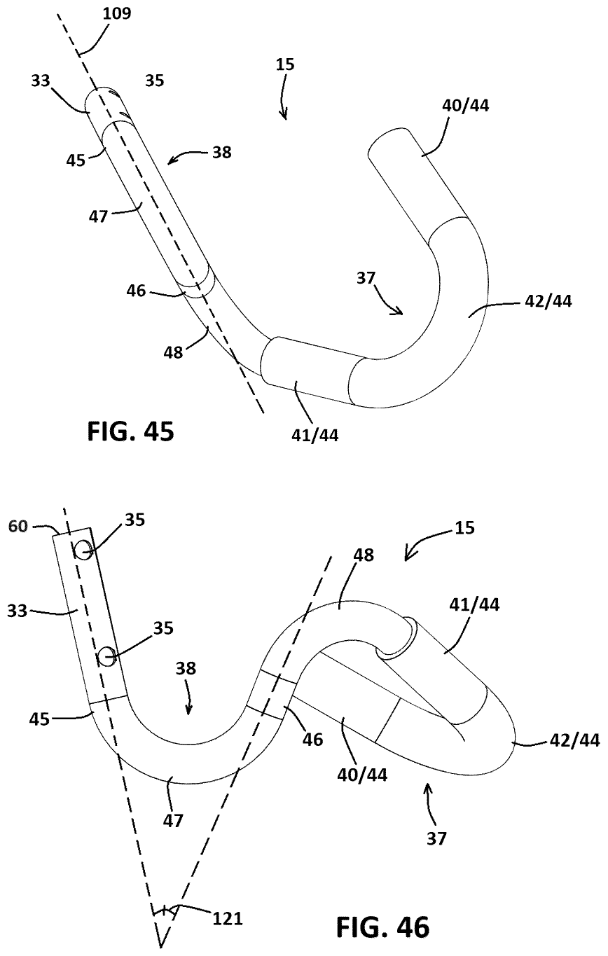

In some embodiments, the proximally located arm support arrangement 15 is generally and tortuously S-shaped in three dimensions and comprises a proximal arm-engaging angled portion 37 and a distal support-to-fulcrum angled portion 38 as depicted and referenced in FIGS. 39-46. The proximal arm-engaging angled portion 37 extends in a first plane 108 and the distal support-to-fulcrum portion 38 extends in a second plane 109. The first and second planes 108 and 109 of the proximal arm-engaging angled portion 37 and the distal support-to-fulcrum portion 38 are angled relative to one another so as to position the proximal arm-engaging angled portion 37 and first plane 108 to extend obliquely at an angle of 20 to 25 degrees as at angle 110 relative to the main tool axis 100. In some embodiments, the first plane 108 of the proximal arm-engaging angled portion 37 extends through a grip end 39 of the upper handle portion 16 as depicted and referenced in FIGS. 33 and 34.

In some embodiments, the proximal arm-engaging angled portion 37 comprises a first support segment 40, a second support segment 41 and a radiused support segment 42 extending intermediate the first and second support segments 40 and 41. The radiused support segment 42 is configured for engaging a lower portion of the user's forearm 106 intermediate the proximal and distal portions thereof and directs balancing force 107 thereinto generally within a vertical plane extending through the main tool axis 100. In some embodiments, the first and second support segments 40 and 41 flank outer portions 126 of the user's forearm 106 for further engaging the user's forearm 106 and increasing the support function of the arm-engaging angled portion 37.

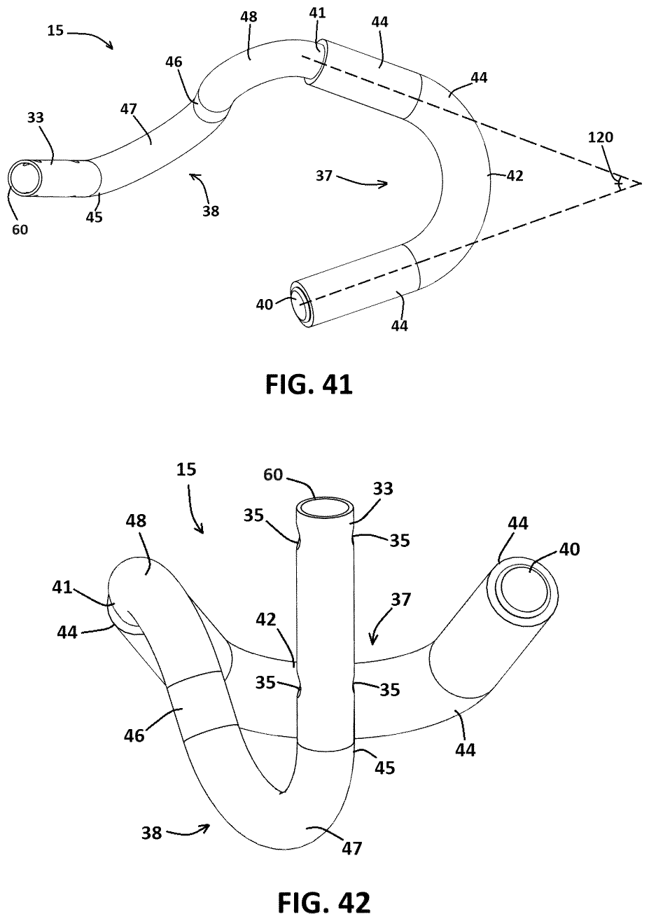

In some embodiments, the first and second support segments 40 and 41 are angled within a range of 30 to 50 degrees, and in some more particular embodiments 40 degrees with respect to one another as at angle 120 as generally depicted in FIG. 41. In some embodiments, at least a portion of the arm-engaging angled portion 37 comprises a padded exterior surface 44 for providing a padded interface intermediate the user's forearm 106 and the arm-engaging angled portion 37 for enhancing comfort at the user's forearm 106 when the balancing force 107 is directed thereinto during use of the grabber tool 10. The padded exterior surface(s) 44 not only help to disperse the balancing force 107 over a larger surface area, but also help stabilize the arm-engaging angled portion 37 at the user' forearm 106.

In some embodiments, the distal support-to-fulcrum angled portion 38 comprises a first angle segment 45 coextensive with the handle mating portion 33, a second angle segment 46, and a radiused angle segment 47 extending intermediate the first and second angle segments 45 and 46. In some embodiments, the first and second angle segments 45 and 46 are within a range of 25 to 45 degrees, and in some embodiments 35 degrees with respect to one another as at angle 121 in FIG. 46. In some embodiments, the distal support-to-fulcrum angled portion 38 is connected to the proximal arm support angled portion 37 by way of a radiused central segment 48 extending intermediate the second angle segment 46 of the distal support-to-fulcrum angled portion 38 and the second support segment 41 of the proximal arm support angled portion 37 thereby providing the three-dimensional tortuous and generally S-shaped arm support arrangement 15.

The arm support arrangement 15 counterbalances loads associated with tools incorporating the arm support arrangement 15 as further discussed in U.S. patent application Ser. No. 18/418,072 from which application these specifications claim a benefit. The arm support arrangement 15 according to the presently disclosed subject matter counterbalances a load associated with a load-bearing tool coextensive with or otherwise attached or connected to or in line with a tool-engaging end 60 of the arm support arrangement 15. In some embodiments, the arm support arrangement 15 according to the presently disclosed subject matter may be said to comprise a tubular body (of tubular metallic material construction) having at least three bends defining two planes and terminating in the tool-engaging end 60.

Stated another way, the arm support arrangement 15 according to the presently disclosed subject matter may be said to comprise a tubular body having an S-shape in three dimensions comprising an upward slanting arm-engaging angled portion as at 37 and a support-to-fulcrum angled portion as at 38. A first of the two planes comprises the upward slanting arm-engaging angled portion 37 opposite the tool-engaging end 60. The arm-engaging angled portion 37 comprises one of the bends disposed between a pair of support segments. First and second support segments of the arm-engaging angled portion 37 are respectively referenced at 40 and 41. Intermediate the first and second support segments 40 and 41 is a bend or radiused support segment as at 42.

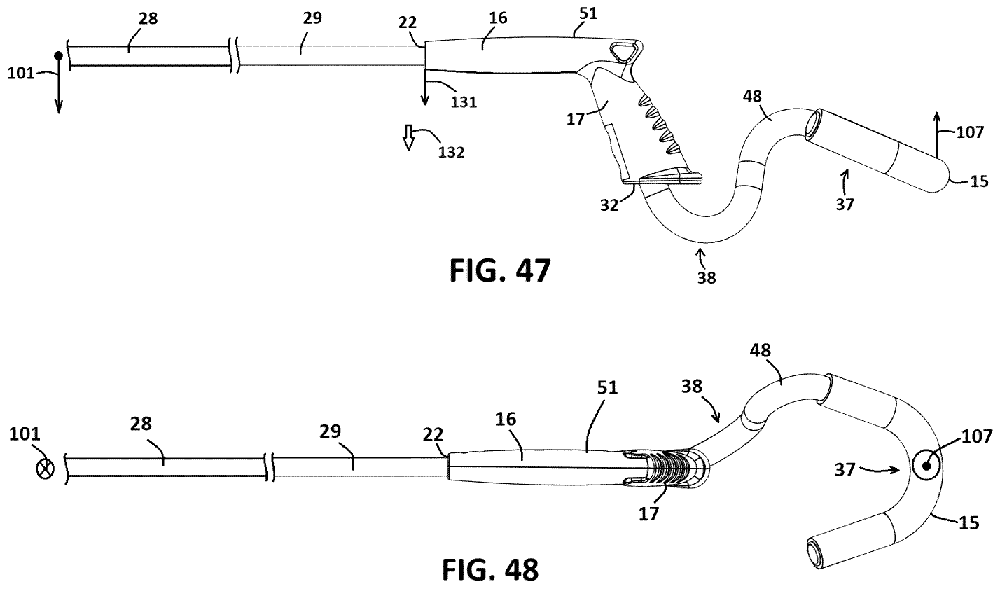

The bends or radiused support segments of the arm support arrangement 15 cooperate to orient an axis 130 of a user's forearm 106 toward the tool-engaging end 60. The tool-engaging end 60 is coextensive with or otherwise attachable to or in line with a load-bearing tool as exemplified by the grabber tool 10 inherently having a tool weight as at 131 in FIG. 47. In some applications, the load-bearing tool may hold a generic object as depicted and referenced at 11, which object 11 has a weight or load as generally referenced at vector 101. The arm support arrangement 15 is coextensive with or attachable to or in line with a load-bearing tool at least a weight 131 of which is directed downwardly as at vector 132 such that the arm-engaging angled portion 37 is directed upwardly toward the user's forearm 106 about a fulcrum point intermediate the tool-engaging end 60 and the arm-engaging angled portion 37 thereby counterbalancing a load associated with the load-bearing tool as exemplified by loads 101 and/or 131. In some embodiments, a handle portion or handle mechanism 12 is provided at the fulcrum point such at which point a user's hand grips the ensemble.

In some embodiments, the arm-engaging angled portion 37 extends in a first plane as at 108 and the support-to-fulcrum angled portion 38 extends in a second plane 109, which first and second planes 108 and 109 are obliquely angled relative to one another. In some embodiments, the first plane 108 extends obliquely relative to the axis 130 of the user's forearm 106 such that the first plane 108 extends through an end 39 of the handle mechanism 12. In some embodiments, the arm-engaging angled portion 37 of the arm support arrangement 15 comprises a first support segment 40, a second support segment 41 and a radiused support segment 42 extending intermediate the first and second support segments 40 and 41 such that the radiused support segment 42 is configured for engaging a first portion of the user's forearm 106.

In some embodiments, the first and second support segments 40 and 41 flank outer portions of the user's forearm 106 for further engaging outer portions of the user's forearm 106 and increasing the support function of the arm-engaging angled portion 37. The support-to-fulcrum angled portion 38 comprises a first angle segment as at 45, a second angle segment as at 46 and a radiused angle segment 47 extending intermediate the first and second angle segments 45 and 46. The support-to-fulcrum angled portion 38 of the arm support arrangement 15 is connected to the arm-engaging angled portion 37 by way of a radiused central segment 48. In some embodiments, the first angle segment 45 is coextensive with a handle mating portion 33 the end of which provides the tool-engaging end 60. In some embodiments, the first angle segment 45 is coextensive with the handle grip portion 17 when mated therewith. The end of the first angle segment 45 provides the tool-engaging end 60.

The presently disclosed subject matter further contemplates usage of the S-shaped arm support arrangement 15 in combination with any number of load-bearing grabber tools, the distal ends of which bear a pincher load or weight 101. In this regard, it is contemplated the arm support arrangement 15 according to the presently disclosed subject matter may similarly transfer the balancing load 107 to a user's forearm 106 for reducing strain at the hand or radiocarpal joint in such applications. A modified handle mechanism 51 may be attached to the arm support arrangement 15 in much the same manner as handle mechanism 12 to provide a fulcrum point for the load balance function opposite an elongate arm portion 52 of such load-bearing tools. The handle mechanism 51, in certain embodiments, may, for example eliminate the trigger mechanism 18 otherwise associated with handle mechanism 12 as generally and comparatively depicted in FIGS. 47 and 48. In some embodiments, the pincher mechanism 14 may be directed by alternative means to a trigger mechanism (e.g., electronically driven mechanisms made operable by way of a button type switch).

While the above descriptions contain much specificity, this specificity should not be construed as limitations on the scope of the presently disclosed subject matter, but rather as an exemplification thereof. In certain embodiments, the presently disclosed subject matter may be said to essentially teach or disclose an arm support arrangement comprising a tubular body having at least three bends defining two planes and terminating in a tool-engaging end. Stated another way, the arm support arrangement comprises a tubular body having an S-shape in three dimensions and comprises an upward slanting arm-engaging angled portion and a support-to-fulcrum angled portion.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end, which tool-engaging end is attachable to a load-bearing tool at least a weight of which is directed downwardly such that the arm-engaging angled portion is directed upwardly toward the user's forearm about a fulcrum point intermediate the tool-engaging end and the arm-engaging angled portion. The arm support arrangement thereby counterbalances a load associated with the load-bearing tool.

In some embodiments, the arm support arrangement comprises a handle portion at the fulcrum point. In some embodiments, the arm support arrangement comprises a fourth bend intermediate the fulcrum point and the tool-engaging end for orienting an axis of the tool-engaging end in parallel relation to the axis of the user's forearm. In some embodiments, the arm-engaging angled portion extends in a first plane and the support-to-fulcrum extends in a second plane, which first and second planes are angled relative to one another. In some embodiments, the first plane extends obliquely relative to the axis of the user's forearm such that the first plane extends through an end of the handle portion.

In some embodiments, the arm-engaging angled portion comprises a first support segment, a second support segment and a radiused support segment extending intermediate the first and second support segments. The radiused support segment is configured for engaging the user's forearm. In some embodiments, the first and second support segments flank outer portions of the user's forearm for further engaging the user's forearm and increasing the support function of the arm-engaging angled portion. In some embodiments, the support-to-fulcrum angled portion comprises a first angle segment, a second angle segment and a radiused angle segment extending intermediate the first and second angle segments. In some embodiments, the support-to-fulcrum angled portion is connected to the arm-engaging angled support angled portion by way of a radiused central segment.

The arm support arrangement according to the presently disclosed subject matter is usable in combination a select load-bearing tool, which select load-bearing tool is selected from the group consisting of a grabber tool and a fishing tool, the latter of which may include a fishing rod or a fishnet tool. In certain embodiments, the presently disclosed subject matter may be said to essentially teach or disclose a grabber tool for enabling a user to grab objects. The grabber tool according to the presently disclosed subject matter comprises a handle mechanism, and elongate arm portion, a pincher mechanism, and an arm support arrangement. The handle mechanism is configured to be ergonomically received in a user's hand and comprises an upper handle portion, a lower handle portion angled relative to the upper handle portion, and a trigger mechanism.

The elongate arm portion extends from a first handle end of the upper handle portion and comprises a proximal handle end and a distal pincher end. The pincher mechanism operably extends from the distal pincher end and is operatively coupled to the trigger mechanism via a force-transmitting mechanism as exemplified by a cable. The trigger mechanism is operable to selectively open and close the pincher mechanism via the force-transmitting mechanism. The arm support arrangement extends from the handle mechanism opposite the elongate arm portion for essentially providing a fulcrum point at the handle mechanism and is configured to engage a user's forearm for providing static equilibrium and countering a pincher mechanism load at the user's forearm and relieving stress at the user's hand.

In some embodiments, the elongate arm portion of the grabber tool may comprise or be outfitted with a pivot mechanism. The optional pivot mechanism enables the user to pivot the distal pincher end relative to the proximal handle end and collapse the grabber tool into a more compact or stowage configuration. In some embodiments, the pivot mechanism may comprise a loop member that extends outwardly from an outer surface thereof for enabling a user to support the grabber tool upon a hook member for storage. In some embodiments, the pivot mechanism which end portions mate with distal and proximal arm portions of the elongate arm portion.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

There is thus provided in accordance with another embodiment of the presently disclosed subject matter a grabber tool for enabling a user to grab objects. The grabber tool comprises a handle mechanism configured to be ergonomically received in a user's hand. The handle mechanism comprises a trigger mechanism configured to enable at least a portion of the user's hand to selectively direct at least a portion of the trigger mechanism in a first direction. The grabber tool further comprises an elongate arm portion. The elongate arm portion extends from the handle mechanism in a direction away from the first direction.

The grabber tool further comprises a pincher mechanism operably extending from the elongate arm portion. The pincher mechanism is operatively coupled to the trigger mechanism, the trigger mechanism being operable to selectively close the pincher mechanism. The grabber tool centrally further includes an arm support arrangement. The arm support arrangement extends from the handle mechanism opposite the elongate arm portion for providing a fulcrum point at the handle mechanism and is configured to engage a user's forearm for providing static equilibrium and countering a grabbed object load at the user's forearm.

In some embodiments, the elongate arm portion may comprise a pivot mechanism, the pivot mechanism for enabling the user to pivot a distal arm portion relative to a proximal arm portion of the elongate arm portion to collapse the grabber tool into a more compact configuration. In some embodiments, the pivot mechanism may comprise a loop member that extends outwardly therefrom for enabling a user to support the grabber tool upon a hook member for storage.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

The various embodiments according to the presently disclosed subject matter may comprise an arm support arrangement substantially as variously described and essentially comprises a tubular body having at least three bends defining two planes and terminating in a tool-engaging end coextensive with or connected to or in line with an elongate arm portion, the distal end of which is configured to bear a pincher mechanism load. In some embodiments, the arm support arrangement comprises a tubular body having an S-shape in three dimensions and comprises an upward slanting arm-engaging angled portion and a support-to-fulcrum angled portion, the latter of which is coextensive with or connected to or in line with an elongate arm portion substantially as earlier described.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end and the elongate arm portion, which tool-engaging end is attachable to a pincher mechanism, the weight of which, whether with or without an object load is directed downwardly such that the arm-engaging angled portion is directed upwardly toward the user's forearm about a fulcrum point intermediate the tool-engaging end and the arm-engaging angled portion. In some embodiments, the arm support arrangement may further comprise a fourth bend intermediate the fulcrum point and the tool-engaging end for orienting an axis of the tool-engaging end and elongate arm portion in parallel relation to the axis of the user's forearm.

Accordingly, although the presently disclosed subject matter has been described by reference to certain embodiments, it is not intended that the novel arm support arrangement and associated applications and methods be limited thereby, but that modifications thereof are intended to be included as falling within the broad scope and spirit of the foregoing disclosures and the appended drawings. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A grabber tool for enabling a user to grab objects, the grabber tool comprising:
a handle mechanism configured to be ergonomically received in a user's hand, the handle mechanism comprising a trigger mechanism configured to enable at least a portion of the user's hand to selectively direct the trigger mechanism;
an elongate arm portion extending distally from the handle mechanism, the elongate arm portion comprising a bendable portion; and
a pincher mechanism operably extending distally from the elongate arm portion and being operatively coupled to the trigger mechanism, the trigger mechanism being operable to selectively close and open the pincher mechanism via the bendable portion.

2. The grabber tool according to claim 1, wherein the handle mechanism comprises an upper handle portion and a lower handle portion obliquely angled relative to the upper handle portion, the trigger mechanism extending intermediate the upper handle portion and the lower handle portion and being directable toward and away from the lower handle portion.

3. The grabber tool according to claim 1, wherein the elongate arm portion comprises a pivot mechanism, the pivot mechanism for enabling the user to pivot the pincher mechanism relative to the handle mechanism and direct the grabber tool into a collapsed configuration.

4. The grabber tool according to claim 1 comprising an arm support arrangement extending proximally from the handle mechanism opposite the pincher mechanism for providing a fulcrum point at the handle mechanism, the arm support arrangement being configured to proximally engage a user's forearm for countering a pincher mechanism load at the user's forearm thereby relieving strain at the user's hand.

5. The grabber tool according to claim 4, wherein the arm support arrangement is S-shaped in three dimensions and comprises an arm-engaging angled portion and a support-to-handle angled portion.

6. The grabber tool according to claim 5, wherein the arm support arrangement comprises a tubular body having at least three bends, said bends cooperating to orient a forearm axis of the user's forearm toward the pincher mechanism.

7. The grabber tool according to claim 6, wherein the arm-engaging angled portion extends in a first plane and the support-to-handle portion extends in a second plane, the first and second planes being angled relative to one another.

8. The grabber tool according to claim 7, wherein the first plane extends obliquely relative to the forearm axis such that the first plane extends through a grip end of the handle mechanism.

9. The grabber tool according to claim 5, wherein the arm-engaging angled portion comprises a first support segment, a second support segment and a radiused support segment extending intermediate the first and second support segments, the radiused support segment being configured for engaging the user's forearm.

10. The grabber tool of claim 9 wherein the first and second support segments flank outer portions of the user's forearm for further engaging the user's forearm and increasing the support function of the arm-engaging angled portion.

11. A grabber tool for enabling a user to grab objects, the grabber tool comprising:
a handle mechanism;
an elongate arm portion extending from the handle mechanism and comprising a bendable portion configurable intermediate a linear configuration and a bent configuration; and
a pincher mechanism extending from the elongate arm portion and being operatively coupled to the handle mechanism, at least a portion of the handle mechanism being directable to close and open the pincher mechanism via the bendable portion.

12. The grabber tool according to claim 11, wherein the handle mechanism comprises a hand-operable trigger mechanism, an upper handle portion and a lower handle portion obliquely angled relative to the upper handle portion, the hand-operable trigger mechanism extending intermediate the upper handle portion and the lower handle portion and being directable toward and away from the lower handle portion.

13. The grabber tool according to claim 11, wherein the elongate arm portion comprises a pivot mechanism, the pivot mechanism for enabling the user to pivot the pincher mechanism relative to the handle mechanism and direct the grabber tool into a collapsed configuration.

14. The grabber tool according to claim 11 comprising an arm support arrangement extending proximally from the handle mechanism opposite the pincher mechanism for providing a fulcrum point at the handle mechanism, the arm support arrangement being configured to engage a user's forearm for countering a pincher mechanism load.

15. The grabber tool according to claim 14, wherein the arm support arrangement is S-shaped in three dimensions and comprises an arm-engaging angled portion and a support-to-handle angled portion.

16. The grabber tool according to claim 15, wherein the arm support arrangement comprises a tubular body having at least three bends, said bends cooperating to orient a forearm axis of the user's forearm toward the pincher mechanism.

17. The grabber tool according to claim 16, wherein the arm-engaging angled portion extends in a first plane and the support-to-handle portion extends in a second plane, the first and second planes being angled relative to one another.

18. The grabber tool according to claim 17, wherein the first plane extends obliquely relative to the forearm axis such that the first plane extends through the handle mechanism.

19. The grabber tool according to claim 15, wherein the arm-engaging angled portion comprises a first support segment, a second support segment and a radiused support segment extending intermediate the first and second support segments, the radiused support segment being configured for engaging the user's forearm.

20. The grabber tool of claim 19 wherein the first and second support segments flank outer portions of the user's forearm for further engaging the user's forearm and increasing the support function of the arm-engaging angled portion.
